(19) United States
(12) Patent Application Publication
(10) Pub. No.: US 2025/0164310 A1
(43) Pub. Date: May 22, 2025

(54) OUTDOOR TIME TRACKING VIA EYEGLASSES

(71) Applicant: Pixieray Oy, Espoo (FI)

(72) Inventors: Klaus Melakari, Espoo (FI); Rebecca Melakari, Espoo (FI)

(73) Assignee: Pixieray Oy, Espoo (FI)

(21) Appl. No.: 18/513,588

(22) Filed: Nov. 19, 2023

(51) Int. Cl. G01J 1/42; G01J 1/02; G01J 1/04; G02C 11/00

(52) U.S. Cl. CPC G01J 1/4204; G01J 1/0238; G01J 1/0403; G01J 1/429; G02C 11/10; G01J 2001/0257; G01J 2001/4266

(57) ABSTRACT

An eyewear and a method for determining user exposure wherein the eyewear includes at least one first sensor attached to a frame of the eyewear and wherein the first sensor is selected from at least one of: ultraviolet light sensor (UVS), photopic ambient light sensor (ALS), and a controller configured to receive values for a photopic light level and an ultraviolet light level from the at least one first sensor, provide a timeline for the received values of the photopic light level and the ultraviolet light level, calculate from the timeline, the photopic light level, and the ultraviolet light level, a probability of time duration the eyewear has been exposed to outdoor environment, and provide the calculated probability of time duration for a user of the eyewear.

### TECHNICAL FIELD

The present disclosure generally relates to optical apparatuses. Specifically, the present disclosure relates to an eyewear. Moreover, the present disclosure relates to a method of determining user exposure via the eyewear.

### BACKGROUND

Solar radiation reaching the earth consists of electromagnetic energy ranging from ultraviolet (UV) light to infrared (IR) light. UV radiation is further subdivided into three types: UV-A, UV-B, and UV-C. UV-C radiation has wavelengths in the range of 200 to 285 nanometres (nm) and is totally absorbed by the earth's atmosphere. UV-B, ranging from about 285 to 318 nm, is known to cause skin cancer in humans. UV-A, from about 315 to 400 nm, is mostly responsible for tanning the skin. However, UV-A has also been found to play some role in skin cancer and is the cause of eye cataracts, solar retinitis, and corneal dystrophies.

Conventionally, eyewear(s) have been utilized to protect the user from such harmful ultraviolet radiation from sunlight, external objects such as, flying debris, insects, and the like. However, exposure to sunlight is deemed crucial for several reasons including, but not limited to, vitamin D production, circadian rhythm regulation, skin health maintenance, mood improvement, and the like. Thus, it is vital to keep track of such exposure to be carefully regulated in moderation for ensuring such exposure to be a boon, and not a bane. Moreover, in modern times, an increasing number of people have been spending excessive amounts of time indoors. Such lifestyles are not healthy from myopia prevention or vitamin production perspectives (especially, for developing eyes). Thus, an appropriate duration of outdoor exposure is typically desired for proper physical and mental wellbeing, and since face of a person is an area that is constantly exposed to sunlight, a need for a system, device, or an apparatus is developed to accurately measure (or track) the exposure to such radiation, for example, ambient light (or sunlight), indoor light (or artificial light), for management thereof.

To fulfil the aforementioned requirements, several UV radiation-measuring and warning solutions have been developed based on general principles and techniques for radiometry and photometry, for example, personal UV radiometers, electronic wristwatches, and the like. However, such solutions are unable to accurately monitor levels of UV radiation when not directly exposed to solar rays, for example, when placed in a shade, or when exposed through windows (or layers). Moreover, such solutions are not optimally convenient, since it is intended to be attached to an article of clothing and may restrict the movement of a person during vigorous physical activity, for instance, a volleyball game. Additionally, aforementioned solutions are based on the assumption that the amount of UV radiation that may be safely tolerated by the human skin is independent of the intensity of incident radiation and is determined primarily based on the total accumulated energy. Even though some prior art-solutions directly measure the intensity level of incident radiation, such measurements are not factored during calculation of safe UV exposure thresholds.

Therefore, in light of the foregoing discussion, there exists a need to overcome the aforementioned drawbacks and provide a device or an apparatus to accurately, reliably, and efficiently, monitor user exposure.

### SUMMARY

The aim of the present disclosure is to provide an eyewear and a method for accurately and reliably determining user exposure via the eyewear in order to monitor and manage such exposure in an efficient and accurate manner. Moreover, the eyewear and the method enables the user to regulate such exposure to maintain a healthy lifestyle i.e., physical and mental well-being and prevent potential side effects occurring from excessive or insufficient exposure to outdoor environments. The aim of the present disclosure is achieved by an eyewear and a method incorporating the eyewear, as defined in the appended independent claims to which reference is made to. Advantageous features are set out in the appended dependent claims.

In a first aspect, the present disclosure provides an eyewear comprising:
at least one first sensor attached to a frame of the eyewear and wherein the first sensor is selected from at least one of: ultraviolet light sensor (UVS), photopic ambient light sensor (ALS), and
a controller configured to:
   receive values for a photopic light level and an ultraviolet light level from the at least one first sensor,
   provide a timeline for the received values of the photopic light level and the ultraviolet light level,
   calculate from the timeline, the photopic light level, and the ultraviolet light level, a probability of time duration the eyewear has been exposed to outdoor environment, and
   provide the calculated probability of time duration for a user of the eyewear.

In a second aspect, the present disclosure provides a method of determining user exposure via the eyewear, comprising:
providing at least one first sensor attached to a frame of the eyewear and wherein the first sensor is selected from at least one of: ultraviolet light sensor (UVS), photopic ambient light sensor (ALS);
receiving values for a photopic light level and an ultraviolet light level from the at least one first sensor,
providing a timeline for the received values of the photopic light level and the ultraviolet light level,
calculating from the timeline, the photopic light level and the ultraviolet light level, a probability of time that the eyewear has been exposed to outdoor environment, and
providing the probability of time for a user of the eyewear.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of an eyewear, in accordance with one or more embodiments of the present disclosure;

FIG. 2 illustrates steps of a method of determining user exposure via the eyewear of FIG. 1, in accordance with one or more embodiments of the present disclosure;

FIG. 3 is a perspective view of an eyewear, in accordance with one or more embodiments of the present disclosure;

FIGS. 4A, 4B, and 4C are illustrations of a front view, a top view, and a side view, respectively, of the eyewear of FIG. 3, in accordance with one or more embodiments of the present disclosure; and

FIGS. 5A, 5B, 5C and 5D are graphical illustrations depicting values of photopic light levels and UV light levels measured via at least one first sensor, in accordance with one or more embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides an eyewear comprising:
at least one first sensor attached to a frame of the eyewear and wherein the first sensor is selected from at least one of: ultraviolet light sensor (UVS), photopic ambient light sensor (ALS), and
a controller configured to:
   receive values for a photopic light level and an ultraviolet light level from the at least one first sensor,
   provide a timeline for the received values of the photopic light level and the ultraviolet light level,
   calculate from the timeline, the photopic light level, and the ultraviolet light level, a probability of time duration the eyewear has been exposed to outdoor environment, and
   provide the calculated probability of time duration for a user of the eyewear.

In a second aspect, the present disclosure provides a method of determining user exposure via the eyewear, comprising:
providing at least one first sensor attached to a frame of the eyewear and wherein the first sensor is selected from at least one of: ultraviolet light sensor (UVS), photopic ambient light sensor (ALS);
receiving values for a photopic light level and an ultraviolet light level from the at least one first sensor,
providing a timeline for the received values of the photopic light level and the ultraviolet light level,
calculating from the timeline, the photopic light level and the ultraviolet light level, a probability of time that the eyewear has been exposed to outdoor environment, and
providing the probability of time for a user of the eyewear.

The present disclosure provides an eyewear and a method for accurately and reliably determining user exposure to outdoor environments, to accurately monitor and thereby regulate such user exposure to maintain enable the user to maintain a healthy lifestyle i.e., physical and mental well-being of the user, while avoiding the potential side effects occurring from excessive, or insufficient, outdoor exposure. The eyewear and the method are simple, robust, support real-time/near-real time feedback to the user, and can be implemented with ease.

Throughout the present disclosure, the term “eyewear” refers to a device or an apparatus configured for tracking user exposure and may be worn over the eyes of a user as appreciated by the terminology. Examples of such eyewear include, but are not limited to, glasses, sunglasses, smart glasses, and head-mounted displays. The eyewear may be used for vision correction, eye protection, or as a fashion accessory. It will be appreciated that although the term eyewear by definition is limited to devices, or apparatuses, associated with the eyes of a user; However, the eyewear of the present disclosure may be interchanged with other wearable devices such as, smart watches, fitness trackers, smart clothing, hearables, and other wearable devices, without any limitations to the present disclosure.

Solar radiation reaching the earth consists of electromagnetic energy ranging from ultraviolet (UV) light to infrared (IR) light. UV radiation is further subdivided into three types: UV-A, UV-B, and UV-C. UV-C radiation has wavelengths in the range of 200 to 285 nanometres (nm) and is totally absorbed by the earth's atmosphere. UV-B, ranging from about 285 to 318 nm, is known to cause skin cancer in humans. UV-A, from about 315 to 400 nm, is mostly responsible for tanning the skin. However, UV-A has also been found to play some role in skin cancer and is the cause of eye cataracts, solar retinitis, and corneal dystrophies.

Conventionally, eyewear(s) have been utilized to protect the user from such harmful ultraviolet radiation from sunlight, external objects such as, flying debris, insects, and the like. However, exposure to sunlight is deemed crucial for several reasons including, but not limited to, vitamin D production, circadian rhythm regulation, skin health maintenance, mood improvement, and the like. Thus, it is vital to keep track of such exposure to be carefully regulated in moderation for ensuring such exposure to be a boon, and not a bane. Moreover, in modern times, an increasing number of people have been spending excessive amounts of time indoors. Such lifestyles are not healthy from myopia prevention or vitamin production perspectives (especially, for developing eyes). Thus, an appropriate duration of outdoor exposure is typically desired for proper physical and mental wellbeing, and since face of a person is an area that is constantly exposed to sunlight, a need for a system, device, or an apparatus is developed to accurately measure (or track) the exposure to such radiation, for example, ambient light (or sunlight), indoor light (or artificial light), for management thereof.

Thus, to overcome the aforementioned drawbacks, the present disclosure provides the eyewear. Herein, the eyewear comprises at least one first sensor (112A, 112B) attached to a frame (114) of the eyewear. Herein, the first sensor is selected from at least one of: ultraviolet light sensor (UVS), photopic ambient light sensor (ALS). The at least one first sensor is configured for measuring an intensity of light incident thereon to keep track of user exposure accurately in order to regulate such exposure and maintain the physical and mental well-being of the user.

Throughout the present disclosure, the term “first sensor” refers to a component capable of detecting and measuring an intensity of light (either indoor, or ambient light) incident thereupon. The at least one first sensor i.e., either the ultraviolet light sensor or the photopic ambient light sensor, may utilize photosensitive materials to produce an electrical signal proportional to the intensity of light they receive. In the eyewear, the at least one first sensor captures sensor data indicative of the ambient light intensity in the environment surrounding the eyewear. The at least one first sensor is positioned in the eyewear so as to accurately capture the ambient light conditions along at least one direction. The at least one first sensor may be arranged either on a surface of the eyewear or may be embedded within its frame, in a manner that ensuring nil or minimal obstruction to the user's vision. The placement of the at least one first sensor may also be chosen to minimize interference or shadowing from other components of the eyewear. In an example, the at least one first sensor may be positioned in a bridge portion of the frame of the eyewear. The at least one first sensor is communicably coupled to the at least one processor, and configured to transmit the sensor data to the at least one processor. The sensor data is then used by the at least one processor to determine the necessary adjustments to be made by the light-control element, for applying the shading intensity to the optical element. By continuously or periodically measuring the ambient light intensity, the at least one first sensor ensures that the shading intensity of the optical element is always in synchronization with the ambient conditions, offering an intensity-optimized strain-free viewing experience to the user.

In an embodiment, the eyewear comprises at least one UV light sensor configured to measure intensity of UV light radiation incident thereon. The UV light sensor includes at least one of a photodiode sensor, photoresistor sensor, silicon carbide sensor, UV fluorescent sensor, UV-activated phototransistor sensor. In another embodiment, the eyewear comprises at least one photopic ambient light sensor (also known as, a lux meter or illuminance sensor) configured to measure intensity of ambient (or visible) light. The photopic ALS includes at least one of photodiode sensor, phototransistor sensor, silicon photomultiplier (SiPM) sensor, and complementary metal-oxide semiconductor (CMOS) image sensor. In yet another embodiment, the eyewear includes both the UV light sensor and the photopic ALS. It will be appreciated that the type of photopic ambient light sensor to be utilized depends on the specific implementational requirements of the embodiment and may be based on at least one of, the required accuracy, the required range of measurement, cost constraints, and power consumption. Optionally, the at least one first sensor is implemented as a visible light sensor. In an example implementation, a given first sensor may be implemented as a photodiode. The photodiode may, for example, be made up of silicon, germanium, indium gallium arsenide, mercury cadmium telluride, and the like. In another embodiment, the eyewear further comprises at least one second sensor for measuring a level of infrared (IR) light received by the eyewear. Typically, the at least one second sensor is operable to detect and measure the level of IR light received by the eyewear to enable the controller of the eyewear to include the IR light exposure along with the photopic light and UV light exposure during further calculations in order to improve the operability and efficacy of the eyewear. In yet another embodiment, the eyewear further comprises a thermal sensor for measuring a temperature of the outdoor environment, or the frame, or the user of the eyewear. The measurement of the temperatures allows management and regulation of exposure of the eyewear and the user and also allows the controller to alert the user in case of detecting excess temperatures to prevent any potential mishaps and ensures safety of the user while employing the eyewear.

The term “ambient light” (or simply, light) refers to light present in the environment. The ambient light could, for example, be natural light (for example, such as sunlight) or an artificial light (for example, light emitted from a lamp, a tube-light, a light-emitting element of a display). Moreover, the term “light intensity” (or simply, intensity) refers to an amount of the ambient light present in the (real-world) environment whereat the eyewear is present. The sensor data may comprise light intensity values (for example, measured in terms of lux or candela per square meter), colour temperature values, luminance values, brightness values, and the like. In some implementations, the at least one first sensor may be implemented as an ambient light sensor. Such light sensors are well-known in the art.

The “frame” refers to a rigid structure (or casing) configured for housing and protecting various internal elements of the eyewear. For example, the frame is configured for holding lenses and housing the at least one sensor and the controller. The frame may be divided internally into various regions for housing different sets of components (or elements) of the eyewear separately, or may comprise a singular region for housing all the elements of the eyewear together. Typically, the frame of the eyewear comprises at least one of a front part, a bridge, a pair of temples (or arms), hinges or coupling elements, nose pads, end-pieces, and rims. The frame may be mechanically coupled, or detachably coupled, with other elements, for firmly holding the various elements of the eyewear. For example, the frame may be mechanically coupled via hinges, bolts, rivets, or fasteners. The frame is shaped and sized to accommodate various elements of the eyewear and may be varied based on the implementational requirements of the present disclosure. In one embodiment, the frame has a length (l), breadth (b) and a height (h), wherein the exact shape and dimensions of the frame are dependent upon the shape and a size of elements being employed in the eyewear. The shape and size of the frame may be varied and the material used for construction of the frame may be selected based on cost constraints, or implementational requirements. The shape of the frame may include, but is not limited to, rectangular, oval, round, aviator, wayfarer, pantos, and the like, whereas the material used to construct the frame may include, but are not limited to, a metal or an alloy, such as, iron, aluminium, steel, silicon, titanium, etc., or a plastic such as, cellulose acetate, propionate, nylon, etc., or a polycarbonate, or a composite thereof. It will be appreciated by a person skilled in the art that the frame may comprise multiple recesses (or slots), lenses, sub-frames, plates, fasteners, hinges, etc., for enabling operation of the eyewear and are not explained herein since being well known in the art and for brevity of the disclosure. In an embodiment, the frame comprises a first temple and a second temple, and wherein the at least one first sensor is attached to a front part of the frame to maximize the amount of the light received by the at least one first sensor. Typically, via arrangement of the at least one first sensor on the front part of the eyewear, the at least one first sensor is enabled to directly receive the incident light on the eyewear and thereby improves the accuracy of the eyewear while maintaining the physical footprint thereof.

The eyewear of the present disclosure further comprises a controller. The term “controller” as used herein refers to a structure and/or module that includes programmable and/or non-programmable components configured to store, process and/or share information and/or signals for performing one or more operations of the eyewear. For example, the controller may be a microcontroller (or microcontroller unit), a processor (or a central processing unit), a graphical processing unit (GPU), a digital signal processor (DSP), an application-specific integrated circuit (ASIC), a field programmable gate array (FPGA), a single board computer (SBC), and the like. The controller is operatively coupled to the at least one first sensor for controlling the functioning or operation of the eyewear. In the present examples, the controller may include components such as memory, a controller, a network adapter, and the like, to store, process and/or share information with other components, such as a temperature sensor, a remote server unit, a database, input-output interfaces, etc. Additionally, the eyewear elements may communicate with each other using a communication interface such as, Wi-Fi, or Bluetooth.

The controller is configured to receive values for a photopic light level and an ultraviolet light level from the at least one first sensor. Typically, the at least one first sensor(s) are configured to measure the values of photopic light levels and UV light levels that may be utilized by the controller for further processing thereof. Upon detection and measurement of the photopic light levels and UV light levels, the measured values are transmitted to the controller operatively coupled therewith. Herein, the photopic light levels refer to the range of light intensities sufficient for color perception and high visual acuity for the user. The photopic light level is measured via the at least one first sensor in terms of candelas per square meter (Cd/m²) or Lux, and typically ranges between 0.01 to 108 Cd/m². Further, the UV light level refer to a measure of intensity of incident UV radiation from the ambient light (e.g., originated from the sun). The UV light level is measured via the at least one first sensor in terms of watt per square meter (W/m²) and typically ranges from 0 to 0.12 W/m². Optionally, additional filters or data processing techniques are implemented via the controller to smooth out any noise or irregularities in the readings (or measured values) from the at least one first sensor to ensure the accuracy of outdoor exposure calculation(s).

The controller is further configured to provide a timeline for the received values of the photopic light level and the ultraviolet light level. Herein, the controller is configured to measure a timeline corresponding to the values of the photopic light level and the ultraviolet light level received from the at least one first sensor. Alternatively stated, the controller is configured to differentiate between two light sources based on the values received from the at least one sensor and record the corresponding activation times, wherein the timeline may be a time duration, or a time stamp. Moreover, the current timeline may be terminated when a substantial change (i.e., above a predefined change threshold) in values of the photopic light level and the ultraviolet light level is detected via the at least one first sensor and correspondingly, a new timeline may be initiated for the updated values of the photopic light level and the ultraviolet light level. In an exemplary implementation, when the at least one first sensor detects a first UV light level i.e., when the value of the UV light level exceeds zero W/m², or when the at least one first sensor detects a first photopic ambient light level i.e., when the value of photopic ambient light level exceeds zero Cd/m², the controller initiates the timeline and continues increasing the time duration as long the values of the first UV light level, or the first photopic ambient light level remains constant, or within a predefined range, or either below or above a predefined threshold. Optionally, the controller may comprise an internal clock (or timer), or a dedicated sensor, for measuring timeline corresponding to the received values of the photopic light level and the ultraviolet light level. In an example, wherein a user enters a first environment, for example, entering an outdoor environment upon exiting a building, the values of the photopic light level and the ultraviolet light level are substantially varied and as a result, the controller initiates a new timeline for the outdoor environment. In another example, when a user enters a second environment, for example, a room, the controller activates the timer when the at least one first sensor is activated upon coming in contact with incident light.

The controller is further configured to calculate from the timeline, the photopic light level, and the ultraviolet light level, a probability of time duration the eyewear has been exposed to outdoor environment. Upon determining the timeline for the received values of the photopic light level and the ultraviolet light level, the controller is further configured to utilize the received values of the photopic light level and the ultraviolet light level along with the provided timeline to calculate the probability of time duration the eyewear has been exposed to the outdoor environment. The term “probability of time duration” refers to either the probability the eyewear, or the user, being exposed to the outdoor environment, or the time duration the eyewear has been exposed to the outdoor environment. The calculation of the probability of duration may be based on at least one of the intensity levels of the photopic and UV light levels, the time duration of exposure, and the like. Optionally, the controller employs a mathematical formula to represent the calculation as follows: Probability of time duration of outdoor exposure for the eyewear=(Σ Outdoor Exposure Segment Durations)/Total Timeline Duration, wherein Σ Outdoor Exposure Segment Durations represents the sum of the durations of all segments where both photopic and UV light levels exceed their respective outdoor environment thresholds, and Total Timeline Duration represents the total duration of the entire timeline. In one or more embodiments, the controller is further configured to compute a ratio of the ultraviolet light level and the photopic light level to determine whether the eyewear is exposed to indoor lighting or ambient lighting. Herein, if the ratio of the UV light level with respect to the photopic light levels exceeds a first threshold, the controller may determine the eyewear as exposed to outdoor lighting. Alternatively, if the ratio of the UV light level with respect to the photopic light levels is below a second threshold, the controller may determine the eyewear as exposed to indoor lighting. For example, the first and second threshold ratios may vary in the range of 0.0001 to 0.001, 0.001 to 0.01, and 0.01 to 0.1.

In an embodiment, the eyewear further comprises a light sensor configured to detect a light pattern of the exposed light. The light sensor may detect the light pattern and transmit the detected readings to the controller for further processing thereof. Further, in another embodiment, the controller is configured to determine whether the eyewear is exposed to indoor lighting or ambient lighting based on the detected light pattern of the exposed light. For example, a flickering light pattern may be indicative of indoor environment, and a continuous light pattern may be indicative of outdoor environment. Such an implementation of an additional light sensor enables verification of the calculations via the controller and thereby ensures the accuracy and efficacy of the eyewear.

In an embodiment, to calculate the probability of time duration, the controller is configured to perform at least one of the following steps including, but not limited to, identification of outdoor environment thresholds i.e., the controller defines thresholds for each of the photopic light level and ultraviolet light level that are characteristic of outdoor environments, wherein the defined thresholds are higher than typical indoor levels to distinguish between indoor and outdoor exposure, segmentation of the calculated timelines based on the values of the received photopic and UV light levels, i.e., the controller divides the calculated timeline into two or more segments based on whether the photopic light level and ultraviolet light level exceed the corresponding defined outdoor environment thresholds, wherein each segment of the timeline represents a period of either indoor exposure, or outdoor exposure, calculation of outdoor exposure duration i.e., the controller is configured to add the segmented durations wherein both the photopic light level and ultraviolet light level exceed their respective outdoor environment thresholds to determine a total exposure time duration, the eyewear has been exposed to the outdoor environment, and normalization of the determined exposure time based on the determined total exposure time duration, wherein the calculated timeline for outdoor exposure is divided by the total exposure time duration to determine the proportion of the total time that the eyewear was likely exposed to outdoor conditions. In a simplified exemplary scenario, wherein the outdoor environment thresholds are set at 1000 lux for photopic light level and 2.0 milliwatts per centimeter square (mW/cm²) for ultraviolet light level, the timeline would be segmented as follows:

| | | Ultraviolet | |
|---|---|---|---|
| | Photopic | Light | |
| Timestamp | Light Level | Level | Exposure |
| 00:00:00 | 200 lux | 0.2 mW/cm² | Indoor |
| 01:00:00 | 800 lux | 1.0 mW/cm² | Indoor |
| 01:30:00 | 1200 lux | 2.5 mW/cm² | Outdoor |
| 02:00:00 | 1500 lux | 3.0 mW/cm² | Outdoor |
| 02:30:00 | 900 lux | 1.8 mW/cm² | Indoor |
| 03:00:00 | 500 lux | 0.7 mW/cm² | Indoor |
| 03:30:00 | 180 lux | 0.2 mW/cm² | Indoor |

In an embodiment, the eyewear is deemed to be exposed to the outdoor environment when the value of the ultraviolet light level is higher than a predetermined threshold. The eyewear or the user employing the eyewear is deemed to be exposed to the outdoor environment, for example, when directly exposed to sunlight, when the received value of the UV light level exceeds the predetermined threshold. The predetermined threshold as used herein refers to a maximum allowable intensity of UV light beyond which a user shall be deemed to be exposed to outdoor environments. For example, on a clear day at sea level, the UV light level of sunlight at Earth's surface is typically between 2.9 and 7.9 mW/cm² and thus, the predetermined threshold is set between 2.9 to 3.1 mW/cm². The controller may be preconfigured with various thresholds or ranges, such as, but not limited to, an indoor threshold or range indicative of the intensity of light generally available at an indoor environment (for example, a room with artificial lighting), an outdoor threshold or range indicative of the intensity of light generally available at an outdoor environment (for example, an open park exposed to UV rays from sunlight), and the like, to determine the indoor and outdoor exposure duration, respectively. It will be appreciated that the specific value of the thresholds may be dependent on the place (or region), the climatic conditions, user behaviour, and the like, and thus, may be varied as per the implementation without any limitations to the present disclosure.

The controller is further configured to provide the calculated probability of time duration for a user of the eyewear. The controller provides the probability of time duration for the user of the eyewear in the form of at least one of a visual indication, or an audible indication. The provision of the calculated probability of time duration may be done either on the eyewear or transmitted to a user device, for example, a smartphone, or computer. Optionally, the eyewear may be configured to provide alerts or warnings to the user, via a feedback unit, when the time duration of outdoor exposure or the indoor exposure increases a maximum allowable time duration. For example, the feedback unit may comprise a speaker, a haptic sensor, a display, configured to provide the alert indicative of requirement of outdoor exposure, or limiting outdoor exposure. Optionally, the controller may be configured to provide suggestions, for example, when outdoor exposure duration is reached, a user may be suggested to wear additional protection such as, caps, or clothing, or to apply sunscreen, and the like.

In one or more embodiments, the controller is further configured to determine a time of sunrise and a time of sunset via a navigation receiver. Further, in another embodiment, the controller is further configured to adjust the probability of duration of time to be provided to the user based on the determined time of sunrise, or the time of sunset. The term “navigation receiver” as used herein refers to a device configured to receive and process signals from navigation satellites to determine the time of sunrise and sunset. For example, the navigation receiver includes, but is not limited to, a GPS receiver, a Global Navigation Satellite System (GNSS) receiver, and inertial navigation system (INS), radio direction finders (RDF), Loran-C receivers, Omega receivers, and the like. Herein, the navigation receiver may be utilized to determine the location of the receiver such as, in terms of longitude and latitude. Further, the controller may be configured to determine a solar declination angle i.e., angle between earth's equator and the incident light (i.e., sunlight). Furthermore, the controller may be configured to determine the hour angle i.e., the angle between the position of sun and the local meridian. Thus, by using the aforementioned values, the controller determines the sunrise angle and the sunset angle to determine the time of the sunrise and the time of sunset, respectively.

In an embodiment, the controller is configured to determine location of the eyewear via the navigation receiver i.e., the latitude and longitude thereof. Further, the solar declination calculated using the following equation: δ=23.45*sin (360*(284+N)/365), wherein ‘δ’ is the solar declination in degrees, and ‘N’ is the day of the year (1 to 365). Furthermore, the controller is configured to determine the hour angle using the following equation: H=ω−λ; wherein, ‘H’ is the hour angle in degrees, ‘ω’ is the Greenwich Mean Time (GMT) in hours, and ‘λ’ is the longitude in degrees. Using the aforementioned calculations, the controller is further configured to calculate the sunrise angle using the following equation: α=arcsine (−tan(δ)*tan(δ)), wherein ‘α’ is the sunrise angle in degrees, ‘δ’ is the solar declination, and ‘φ’ is the latitude. Moreover, the controller is configured to calculate the sunset angle using the following equation: β=arcsine (−tan(δ)*tan(δ)), wherein ‘β’ is the sunset angle in degrees, ‘δ’ is the solar declination, and ‘φ’ is the latitude. Based on the above calculations, the controller is enables to calculate the sunrise and sunset times via the following equations: Sunrise time=GMT−H/15, and Sunset time=GMT+H/15; wherein, ‘H’ is the hour angle calculated previously. It is appreciated that these equations are only illustrative and actual equations used by the controller may vary to improve the accuracy of the calculation by taking into account additional factors, such as atmospheric refraction and cloud cover. In an example, wherein a current location of the eyewear as determined via the navigation receiver is: Latitude: 40° N, Longitude: 100° W, as on date: Aug. 4, 2023. The controller makes the following calculations to determine the sunrise time and sunset time:

$$The solar declination : δ = 23.45 * sin ( 360 * ( 284 + 214 ) / 365 ) = 15.9 ° \\ The hour angle : H = 12 - 100 / 15 = 7.33 ° \\ The sunrise angle : α = arc sine ( - tan ( δ ) * tan ( φ ) ) = - 29. ° \\ The sunset angle : β = arc sine ( - tan ( δ ) * tan ( φ ) ) = 29. ° \\ The sunrise time = GMT - H / 15 = 05 : 27$$

The sunset time=GMT+H/15=19:03; Therefore, the time of sunrise and sunset on Aug. 4, 2023 at 40° N and 100° W is 05:27 and 19:03 GMT, respectively.

In an embodiment, the eyewear further comprises at least one inertial measurement unit (IMU) for determining an orientation, or a change of orientation, of the eyewear. The determined orientation, or change thereof, is factored into the calculations by the controller to enhance the accuracy thereof. In another embodiment, the controller is further configured to determine an angle of ultraviolet light, or photopic light, received by the eyewear based on at least one of the photopic light level, the ultraviolet light level, the orientation, or the change of orientation of the eyewear. The orientation of the eyewear, or change thereof, along with the values of the UV light levels and the photopic light levels enables ensuring the accuracy of calculations via the controller and thereby improves the efficacy of the eyewear.

The present disclosure also relates to the second aspect as described above. Various embodiments and variants disclosed above, with respect to the aforementioned first aspect, apply mutatis mutandis to the second aspect. In the second aspect, the present disclosure provides a method of determining user exposure via the eyewear.

The method comprises providing at least one first sensor attached to a frame of the eyewear and wherein the first sensor is selected from at least one of: ultraviolet light sensor (UVS), photopic ambient light sensor (ALS). The method further comprises receiving values for a photopic light level and an ultraviolet light level from the at least one first sensor. The at least one first sensor is configured to detect and measure the values of the photopic light level and the ultraviolet light level in order to enable further processing via the method in order to determine user exposure therefrom. The method further comprises providing a timeline for the received values of the photopic light level and the ultraviolet light level. The timeline associated with each of the photopic light level and the ultraviolet light level is provided by the controller for further processing thereof. The method further comprises calculating from the timeline, the photopic light level and the ultraviolet light level, a probability of time that the eyewear has been exposed to outdoor environment. The provided timeline along with each of the photopic light level and the ultraviolet light level is utilized in order to determine the probability of time duration, or simply the time duration of the user exposure. The method further comprises providing the probability of time for a user of the eyewear, wherein the probability is indicative of the accuracy of the time duration of outdoor exposure of the eyewear determined via the method and whether sufficient exposure is experience or not.

Optionally, the method further comprises comparing the value of the ultraviolet light level with a predetermined threshold, wherein the eyewear (100) is deemed to be exposed to the outdoor environment.

Optionally, the method further comprises determining time of sunrise and time of sunset based on the provided timeline.

Optionally, the method further comprises adjusting the value of the probability of time to be provided to the user based on the time of sunrise and sunset.

Optionally, the method further comprises determining an orientation, or a change of orientation, of the eyewear (100) via at least one inertial measurement unit (IMU).

Optionally, the method further comprises determining an angle of ultraviolet or photopic light received by the eyewear based on the photopic light level or the ultraviolet light level, and the orientation or change of orientation.

Optionally, the method further comprises computing a ratio of the ultraviolet light level and the photopic light level to determine whether the eyewear (100) is exposed to indoor lighting or ambient lighting.

Optionally, the method further comprises detecting a light pattern of the exposed light via a light sensor (120) to determine whether the eyewear (100) is exposed to indoor lighting or ambient lighting.

Optionally, if the ambient light sensor is a RGB ambient light sensor, that can be used to calculate colour temperature of the incoming light. Strong mismatch between the time of day and colour temperature would rule out natural light. Most of the indoor lights are relatively warm <3000 k (k=Kelvin) at typical homes and even in offices around <4500 k. In some very special areas like factories, light temperature may be above 5000 k. However, natural light tends to be most of the day much higher than 4000 k.

### DETAILED DESCRIPTION OF THE DRAWINGS

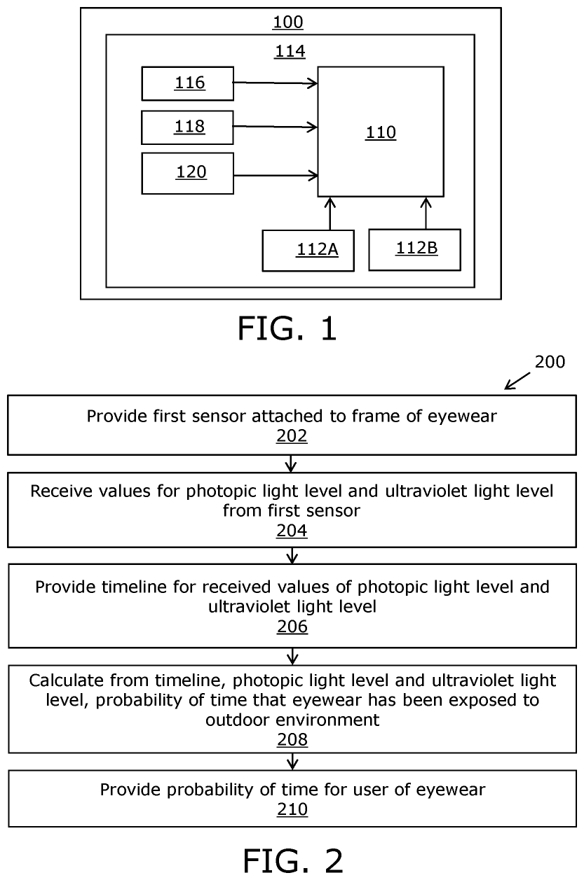

Referring to FIG. 1, illustrated is a block diagram of an eyewear 100, in accordance with one or more embodiments of the present disclosure. As shown, the eyewear 100 comprises at least one first sensor 112A, 112B attached to a frame 114 of the eyewear, wherein the first sensor is selected from at least one of: ultraviolet light sensor (UVS), photopic ambient light sensor (ALS). The eyewear 100 further comprises a controller 110 configured to manage the operations of the eyewear 100. Optionally, the eyewear 100 further comprises a thermal sensor 116 for measuring a temperature of the outdoor environment, or the frame 114, or the user of the eyewear 100. Further, optionally, the eyewear further comprises at least one second sensor 118 for measuring a level of infrared (IR) light received by the eyewear 100. Furthermore, optionally, the eyewear 100 further comprises a light sensor 120 configured to detect a light pattern of the exposed light.

Referring to FIG. 2, illustrated are steps of a method 200 for determining user exposure via the eyewear 100 of FIG. 1, in accordance with one or more embodiments of the present disclosure. Herein, the method 200 comprises steps 202, 204, 206, 208 and 210. As shown, at a step 202, the method 200 comprises providing at least one first sensor 112A, 112B attached to a frame 114 of the eyewear 100 and wherein the first sensor 112A, 112B is selected from at least one of: ultraviolet light sensor (UVS), photopic ambient light sensor (ALS). At a step 204, the method 200 further comprises receiving values for a photopic light level and an ultraviolet light level from the at least one first sensor 112A, 112B. At a step 206, the method 200 further comprises providing a timeline for the received values of the photopic light level and the ultraviolet light level. At a step 208, the method 200 further comprises calculating from the timeline, the photopic light level and the ultraviolet light level, a probability of time that the eyewear 100 has been exposed to outdoor environment. And, at a step 210, the method 200 comprises providing the probability of time for a user of the eyewear 100.

The aforementioned steps are only illustrative and other alternatives can also be provided where one or more steps are added, one or more steps are removed, or one or more steps are provided in a different sequence without departing from the scope of the claims herein.

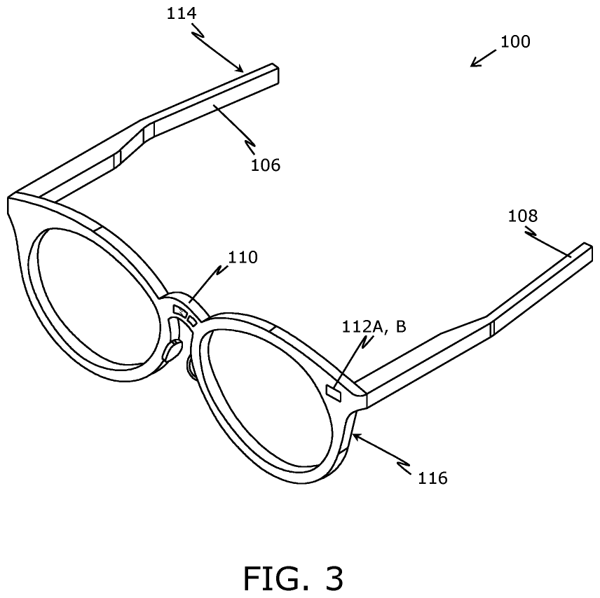

Referring to FIG. 3, illustrated is a perspective view of the eyewear 100 of FIG. 1, in accordance with one or more embodiments of the present disclosure. As shown, the eyewear 100 comprises at least one first sensor 112A, 112B attached to a frame 114 of the eyewear, wherein the first sensor is selected from at least one of: ultraviolet light sensor (UVS), photopic ambient light sensor (ALS). The frame 114 comprises a first temple 106 and a second temple 108, and wherein the at least one first sensor 112A, 112B is attached to a front part 116 of the frame 114 to maximize the amount of the light received by the at least one first sensor 112A, B. The eyewear 100 further comprises a controller 110 configured to manage the operations of the eyewear 100. Optionally, the eyewear 100 further comprises a thermal sensor 116 for measuring a temperature of the outdoor environment, or the frame 114, or the user of the eyewear 100. Further, optionally, the eyewear 100 further comprises at least one second sensor 118 for measuring a level of infrared (IR) light received by the eyewear 100. Furthermore, optionally, the eyewear 100 further comprises a light sensor 120 configured to detect a light pattern of the exposed light.

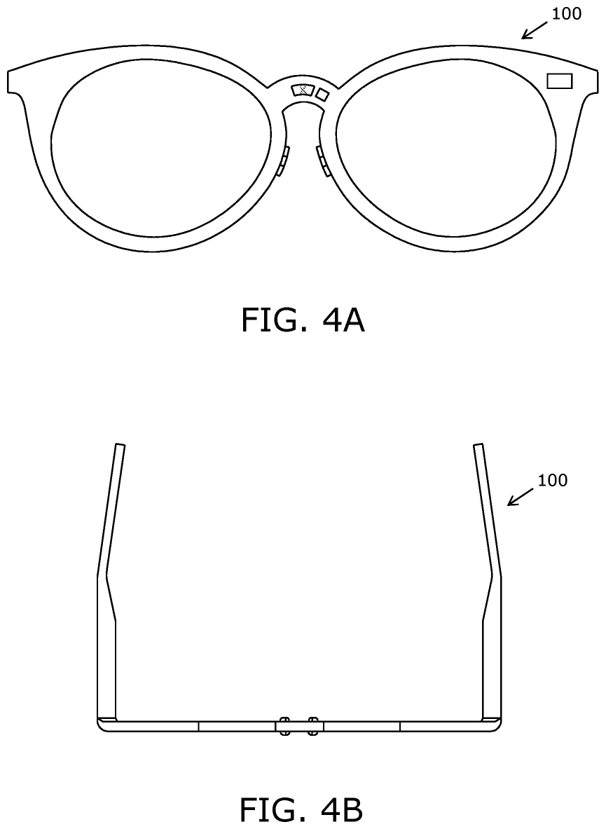

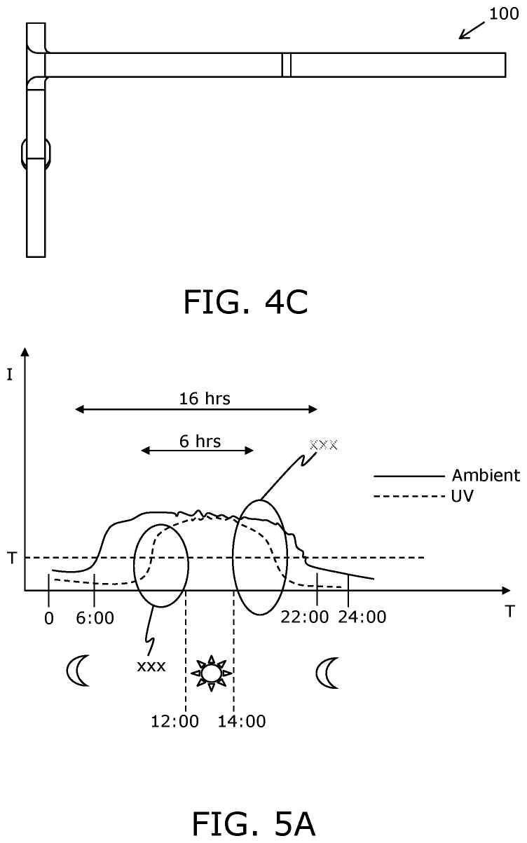

Referring to FIGS. 4A to 4C, illustrated are different views of the eyewear 100 of FIG. 3, in accordance with one or more embodiments of the present disclosure. Typically, FIG. 4A illustrates a front view of the eyewear 100, FIG. 4B illustrates a top view of the eyewear 100, and FIG. 4C illustrates a side view of the eyewear 100.

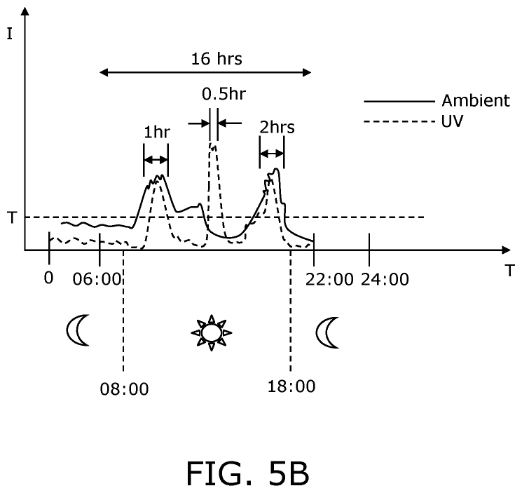

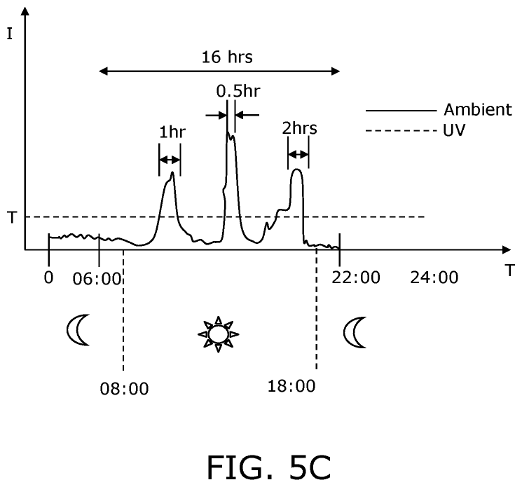

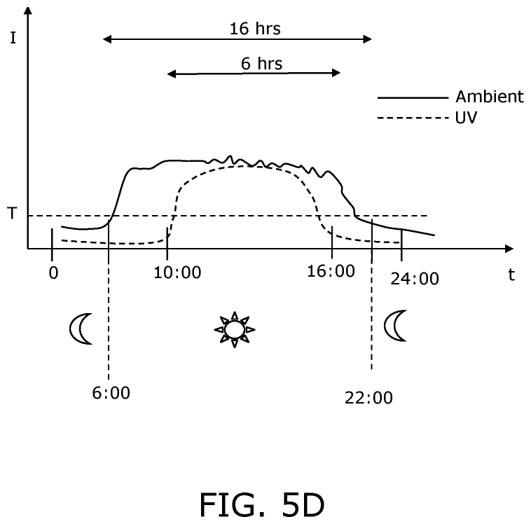

Referring to FIGS. 5A to 5D, collectively, illustrated are graphical illustrations depicting values of photopic light level and UV light level measured via at least one first sensor 112A, 112B of the eyewear 100 of FIG. 1, in accordance with one or more embodiments of the present disclosure. Herein, the x-axis depicts the timeline and y-axis depicts values of intensity of incident light. The photopic light (or ambient light) level is depicted by a solid line and the UV light level is depicted by a dotted line. As shown, the at least one first sensor 112A, 112B is configured to measure the values of the photopic or ambient light levels and the UV light levels of the light incident on the eyewear. Based on the readings, a threshold ‘T’ is set by the controller 110 in order to determine whether the eyewear 100 is exposed to the outdoor environment or not. Typically, if the values of the photopic light level and the UV light level are above the threshold T, then the controller 110 deems the eyewear as exposed to the outdoor environment. Alternatively, if found below the threshold T, the eyewear 100 is deemed as being present in an indoor environment. Optionally, the controller 110 is configured to adjust the probability of duration of time to be provided to the user based on the determined time of sunrise, or the time of sunset. It will be appreciated that the time of sunrise and sunset, as shown herein, is set at 600 hrs and 2200 hrs, respectively, is only illustrative and not exact timings.

1. An eyewear comprising:
at least one first sensor attached to a frame of the eyewear and wherein the first sensor is selected from at least one of: ultraviolet light sensor (UVS), photopic ambient light sensor (ALS), and
a controller configured to:
receive values for a photopic light level and an ultraviolet light level from the at least one first sensor,
provide a timeline for the received values of the photopic light level and the ultraviolet light level,
calculate from the timeline, the photopic light level, and the ultraviolet light level, a probability of time duration the eyewear has been exposed to outdoor environment, and
provide the calculated probability of time duration for a user of the eyewear.

2. The eyewear of claim 1, wherein the eyewear is deemed to be exposed to the outdoor environment when the value of the ultraviolet light level is higher than a predetermined threshold.

3. The eyewear of claim 1, wherein the controller (110) is further configured to determine a time of sunrise and a time of sunset via a navigation receiver.

4. The eyewear of claim 3, wherein the controller is further configured to adjust the probability of duration of time to be provided to the user based on the determined time of sunrise, or the time of sunset.

5. The eyewear of claim 1, wherein the frame comprises a first temple and a second temple, and wherein the at least one first sensor is attached to a front part of the frame to maximize the amount of the light received by the at least one first sensor.

6. The eyewear of claim 1, further comprises at least one inertial measurement unit (IMU) for determining an orientation, or a change of orientation, of the eyewear.

7. The eyewear of claim 1, wherein the controller is further configured to determine an angle of ultraviolet light, or photopic light, received by the eyewear based on at least one of the photopic light level, the ultraviolet light level, the orientation, or the change of orientation of the eyewear.

8. The eyewear of claim 1, further comprises a thermal sensor for measuring a temperature of the outdoor environment, or the frame, or the user of the eyewear.

9. The eyewear of claim 1, further comprises at least one second sensor for measuring a level of infrared (IR) light received by the eyewear.

10. The eyewear of claim 1, wherein the controller is further configured to compute a ratio of the ultraviolet light level and the photopic light level to determine whether the eyewear is exposed to indoor lighting or ambient lighting.

11. The eyewear of claim 1, further comprises a light sensor configured to detect a light pattern of the exposed light.

12. The eyewear of claim 11, wherein the controller is configured to determine whether the eyewear is exposed to indoor lighting or ambient lighting based on the detected light pattern of the exposed light.

13. A method of determining user exposure via the eyewear, comprising:
providing at least one first sensor attached to a frame of the eyewear and wherein the first sensor is selected from at least one of: ultraviolet light sensor (UVS), photopic ambient light sensor (ALS);
receiving values for a photopic light level and an ultraviolet light level from the at least one first sensor,
providing a timeline for the received values of the photopic light level and the ultraviolet light level,
calculating from the timeline, the photopic light level and the ultraviolet light level, a probability of time that the eyewear has been exposed to outdoor environment, and
providing the probability of time for a user of the eyewear.

14. The method of claim 13, further comprising comparing the value of the ultraviolet light level with a predetermined threshold, wherein the eyewear is deemed to be exposed to the outdoor environment.

15. The method of claim 13, further comprising determining time of sunrise and time of sunset based on the provided timeline.

16. The method of claim 13, further comprising adjusting the value of the probability of time to be provided to the user based on the time of sunrise and sunset.

17. The method of claim 13, further comprising determining an orientation, or a change of orientation, of the eyewear via at least one inertial measurement unit.

18. The method of claim 13, further comprising determining an angle of ultraviolet or photopic light received by the eyewear based on the photopic light level or the ultraviolet light level, and the orientation or change of orientation.

19. The method of claim 13, further comprising computing a ratio of the ultraviolet light level and the photopic light level to determine whether the eyewear is exposed to indoor lighting or ambient lighting.

20. The method of claim 13, further comprising detecting a light pattern of the exposed light via a light sensor to determine whether the eyewear is exposed to indoor lighting or ambient lighting.
